(19) United States
(12) Patent Application Publication
(10) Pub. No.: US 2024/0287304 A1
(43) Pub. Date: Aug. 29, 2024

(54) GENERATIVE MANUFACTURING METHODS FOR PRODUCING THREE-DIMENSIONAL OBJECTS

(71) Applicant: Technische Universität Wien, Wien (AT)

(72) Inventors: Robert LISKA, Schleinbach (AT); Raffael Johannes Bodo WOLFF, Tubling (AT); Patrick KNAACK, Wien (AT); Jürgen STAMPFL, Wien (AT); Katharina EHRMANN, Wien (AT)

(21) Appl. No.: 18/570,045

(22) PCT Filed: Jun. 14, 2022
(86) PCT No.: PCT/EP2022/066196

§ 371 Date: Dec. 13, 2023

(30) Foreign Application Priority Data
Jun. 14, 2021 (AT) A 112/2021

(51) Int. Cl. C08L 61/14; B29C 64/124; B29K 61/00; B33Y 10/00; B33Y 70/00

(52) U.S. Cl. CPC C08L 61/14; B29C 64/124; B29K 2061/00; B33Y 10/00; B33Y 70/00

(57) ABSTRACT

The use of a photopolymerizable composition containing a phenol formaldehyde resin, a curing agent, and a photoinitiator in a generative manufacturing method for producing three-dimensional objects by irradiating it layer by layer to cure the composition is described. The use involves the following steps:
a) the composition is heated to a reaction temperature of at least 70° C. before and during curing;
b) the composition contains:
   b1) a novolak as said phenol formaldehyde resin,
   b2) a formaldehyde derivative stable at the reaction temperature as said curing agent, and
   b3) a photoacid generator as said photoinitiator; and
c) curing of the composition is conducted at normal pressure;
   with the proviso that the curing agent is not an amine-containing formaldehyde derivative.

The present invention relates to generative manufacturing methods for producing three-dimensional objects by utilizing photopolymerizable compositions comprising phenol formaldehyde resins.

### STATE OF THE ART

Phenoplasts obtainable by curing phenolic resins are among the first industrially produced plastics, and the first phenol formaldehyde resin, invented as early as 1907, is still sold under the trademark Bakelite. These polycondensates are known for their chemical resistance, excellent flame properties and thermal stability, which is why they are, for example, used in the aerospace and automobile industries. Due to the relatively large amount of water formed during polycondensation, shaping processing with a simultaneous curing of phenolic resins is usually not only conducted at elevated temperatures to promote condensation, but also under very high pressures of sometimes even more than 150 bar in order to prevent the water from evaporating and escaping, which might otherwise lead to the formation of bubbles. In addition, processing was mainly limited to injection molding and melt pressing, with press boards being among the most famous examples of products based on phenol formaldehyde resins as binders.

On the other hand, lithography-based generative manufacturing methods in which a material curable thermally or by photoinduction is applied layer by layer and cured, which can be summarized with the expression of 3D printing, have traditionally been used mainly for producing prototypes and functional samples (“rapid prototyping”), however, due to technical developments such methods are now also increasingly being used in industrial production, e.g., for transparent dental braces or hearing aid shells. Here, the mechanical and thermal properties of the printing materials are of vital importance. However, most of the materials available for 3D printing do not yet have the mechanical properties of conventional manufacturing materials. These materials, i.e., resins, are based on reactive components that are cured by heating or irradiating, for which usually free radical (e.g., for acrylates) or cationic (e.g., for epoxys) polymerization is used. For photoinduced curing, photoinitiators are added to the resin in order to initiate polymerization of the reactive components.

Various methods are available for generative manufacturing of objects made of these resins, e.g., stereolithography, Digital Light Processing, and Multi-Jet Modeling. In all methods, these resins are cured layer by layer to produce a three-dimensional object. Usually, this requires resins with low viscosities, e.g., 20-40 mPa·s (see I. Gibson, D. W. Rosen, B. Stucker, et al., “Additive Manufacturing Technologies”, Vol. 238, Springer (2010)).

In order to improve the mechanical properties, in particular the toughness or elongation at break, of products cured in this way, however, the crosslinking density of the monomers has to be reduced and their molecular weight has to be increased. However, this increases the viscosities and/or the melting points of the uncured resins, which is why they could not be cured with generative manufacturing methods until recently. However, newer developments make it possible to also process resins having higher viscosities. For example, WO 2015/075094 A1 and WO 2016/078838 A1 disclose stereolithography devices in which the layers of polymerizable material that are to be cured sequentially can be heated, which allows the processing of even highly viscous resins. WO 2015/074088 A2 discloses photopolymerizable compositions having dynamic viscosities of at least 20 Pa·s at room temperature, which are heated to at least 30° C. during curing (“hot lithography”). By comparison: 20 Pa·s correspond approximately to the viscosity of ethylene glycol or viscous honey, whereas butter having a viscosity of approximately 30 Pa·s is hardly capable of flowing.

However, problems that remain unsolved relate to the mechanical properties of the cured 3D printed parts. For example, they have insufficient impact strength and elasticity, are too brittle and absorb too much water from ambient air.

Due to their good mechanical properties, phenolic resins have already been examined with regard to printing applications, including 3D printing. For example, CN 103980657 A from 2014 discloses compositions comprising phenolic resins that are supposed to be suitable for 3D printing. They each comprise a thermally curable novolak resin, a second resin with a low molecular weight selected form phenolic resins, polyvinyl alcohols and polyacrylates, diisocyanates as chain extenders, allylamine or butenamine as a capping agent, polyunsaturated fatty acids as crosslinkers, as well as toughness and strength modifiers. These compositions are produced in a twin-screw extruder by mixing the two resins, heating the mixture to more than 150° C. for melting them, subsequently adding the chain extender, capping agent, crosslinker and strengtheners, and extruding and granulating the mixture. Processing of the granulate into three-dimensional articles is carried out by a 3D printing process referred to as “melt extrusion accumulation molding”, in which layers of the re-melted granulate are applied one after the other and hardened by cooling. Photopolymerization is thus not mentioned.

RU 2699556 C1 from 2019 discloses mixtures of a special phenolic resin modified with propargyl halide groups, a photopolymerizable vinylester resin based on bisphenol A, and a radical photoinitiator. For processing these mixtures, the vinylester resin is initially photopolymerized by irradiation, followed by thermal curing of the modified phenolic resin in the solid product thus obtained. Suitable phenolic resins disclosed are resols and novolaks, and possible applications mentioned are the production of polymeric films, three-dimensional products and prototypes via stereolithography. In fact, the individual mixtures are only introduced between two glass plates and subsequently cured in two stages, i.e., by initial irradiation followed by heating. JP 2019/203097 A discloses special cresol-based novolak resins with OH groups partly protected with 1-ethoxyethyl to be used in photoresists.

US 2002/076651 A1 discloses compositions for thick-film photoresists in which “epoxidized polyfunctional bisphenol A formaldehyde novolak resins” are used, i.e., novolak resins modified with several, preferably eight each, epoxy groups per molecule that are relevant for polyaddition into epoxy resins; and WO 2017/112653 also—in addition to a plurality of other resins—discloses epoxidized phenol formaldehyde resins for use in photopolymerizable compositions. However, the latter comprise two different polymerizable precursor compositions that are supposed to result in preferably interpenetrating polymer networks (IPN) when cured. As precursors of such resins, which are to be epoxidized, also resols can be used in addition to novolaks. In both disclosures, more or less highly crosslinked epoxy resins are obtained after curing induced by photoacid generators, which comprise (or according to WO 2017/112653 A1: may comprise) the respective phenolic resin components.

Against this background, it was the object of the present invention to develop photopolymerizable compositions from which three-dimensional molded articles having improved mechanical properties compared to the state of the art are obtainable by means of generative manufacturing methods, i.e., 3D printing.

### DISCLOSURE OF THE INVENTION

In a first aspect, the present invention achieves this object by providing the use of a photopolymerizable composition comprising a phenol formaldehyde resin, a curing agent, and a photoinitiator in a generative manufacturing method for producing three-dimensional objects by irradiating it layer by layer to cure the composition, wherein the method is characterized in that
a) the composition is heated to a reaction temperature of at least 70° C. before and during curing;
b) the composition comprises
   b1) a novolak as said phenol formaldehyde resin,
   b2) a formaldehyde derivative stable at the reaction temperature as said curing agent, and
   b3) a photoacid generator as said photoinitiator; and
c) curing of the composition is conducted at normal pressure;
   with the proviso that the novolak does essentially not comprise any other functionalities participating in the photopolymerization in addition to the OH groups; and
   with the further proviso that the curing agent is not an amine-containing formaldehyde derivative.

In other words, the invention provides a generative manufacturing method for producing three-dimensional objects by irradiating, layer by layer, a photopolymerizable composition comprising a phenol formaldehyde resin, a curing agent, and a photoinitiator, which is, as mentioned above, characterized in that
a) the composition is heated to a reaction temperature of at least 70° C. before and during curing;
b) the composition comprises
   b1) a novolak as said phenol formaldehyde, which has a viscosity of not more than 20 Pa·s at the reaction temperature,
   b2) a formaldehyde derivative stable at the reaction temperature as said curing agent, and
   b3) a photoacid generator as said photoinitiator; and
c) curing of the composition is conducted at normal pressure;
   with the proviso that the curing agent is not an amine-containing formaldehyde derivative.

Surprisingly, the inventors have discovered that for the polycondensation of novolaks, i.e., of phenolic resins having a formaldehyde-phenol ratio of less than 1:1, initiated by photoacid generators with simultaneous crosslinking with formaldehyde derivatives no elevated pressure is required to prevent the water formed by the condensation reactions from escaping, even at reaction temperatures of more than 100° C.

Without wishing to be bound by a specific theory, the inventors assume that this is due to the high curing rates of the photopolymerizable compositions in the inventive method. These are mainly due to the fact that during irradiation, the photoacid generators used as photoinitiators release very strong acids, in some embodiments even superacids, such as hexafluoroantimonate. Due to this enormous acidity, the catalytic activities of the photoacid generators and the reaction rates thus achieved are also so high that the water molecules released during polycondensation cannot reach the surface of the respective layer undergoing curing and cannot evaporate before the viscosity of the composition, that is simultaneously rising quickly, does not allow the release of any water from the interior anymore. When using resol resins, i.e., phenolic resins having a formaldehyde-phenol ratio of more than 1:1, which have free primary hydroxy groups and are usually self-curing, however, this mechanism does not work, as will be proven in the examples and comparative examples below.

Due to the elevated temperatures of at least 70° C. used in the inventive method, novolaks having a relatively high molecular weight can also be used as starting resins, while the reaction mixtures remain mixable, i.e., stirrable, as long as the resins have a viscosity of not more than 20 Pa·s at the respectively selected reaction temperature. In this way, the present invention allows the production of three-dimensional objects based on phenolic resins with unprecedented mechanical properties.

As mentioned at the beginning, a viscosity of 20 Pa·s corresponds approximately to that of ethylene glycol or of viscous honey. Nevertheless, novolaks having a viscosity within this limit at the reaction temperature are suitable according to the present invention, sometimes, if required, by adding a defined (low) amount of novolak having a low molecular weight or one or more other viscosity-reducing additives, however, preferably by using a formaldehyde derivative as said curing agent that is present in its liquid state at the reaction temperature. For this purpose, the formaldehyde derivative used as said curing agent is preferably selected from polyoxymethylene, polyoxymethylene diesters, polyoxymethylene diethers, as well as derivatives of 1,3-dioxolane and 1,3-dioxane, more preferably from 4-phenyl-1,3-dioxane as well as polyoxymethylene diacetate and other polyoxymethylene diesters, which are, on the one hand, liquid at the respective reaction temperature, and also, in the case of the diesters, each consume two molecules of water during the acid-catalyzed cleavage of the diester molecule.

In addition, all of these curing agents are, as disclosed before, thermally stable insofar as they do not release any formaldehyde at the respective reaction temperature as long as no irradiation of the reaction mixture for cleaving the photoacid generator has been conducted. With regard to contour accuracy of the three-dimensional objects to be produced generatively, this is an essential feature of the present invention. However, since sometimes large amounts of ammonia, which might neutralize the photoacid in the inventive method, are released during the decomposition of amine-containing formaldehyde derivatives, e.g., of hexamethylenetetramine regularly used as said curing agent of phenolic resins, such curing agents are excluded from the scope of the present invention.

Alternatively—or in addition—preferred embodiments of the invention use a novolak as said phenol formaldehyde resin, which has a viscosity of not more than 10 Pa·s, not more than 5 Pa·s or not more than 1 Pa·s at the reaction temperature, in order not to be limited too much with regard to the selection of the curing agent and/or in order to be able to add further additives, such as other resins, e.g., also those having a relatively high molecular weight, to the reaction mixture. However, according to the invention, the latter is only preferred in certain cases.

In general, it should be noted that the novolak used according to the present invention comprises substantially no—preferably truly no—other functionalities participating in the photopolymerization in addition to the OH groups so that curing is practically achieved exclusively by polycondensation between phenol groups of the novolak and the formaldehyde groups of the curing agent. Herein, “substantially no” means that only in exceptional cases, a small amount of such other functionalities can be present in order to slightly modify a certain parameter of the obtained polycondensates, if necessary. Herein, a small amount is a single-digit molar percentage based on the average number of OH groups of the novolak, such as 1 to 5 or 1 to 2 mol %.

The photoacid generator used as said photoinitiator according to the present invention is not particularly limited so that, in principle, any commonly used compound available on the marked is eligible. Preferably, however, the photoacid generator is selected from diaryliodonium and triarylsulfonium salts, more preferably from their hexafluoroantimonate, tetrafluoroborate and tetrakis(pentafluorophenyl)borate salts, which have proven to be suitable as photoacid generators under various reaction conditions in the past and also release extremely strong acids, sometimes even superacids, when irradiated. Of course, the wavelength used for irradiation also depends on the selected photoacid generator.

In further preferred embodiments of the present invention, the composition is heated to a reaction temperature of not more than 130° C. in order not to cause any thermal decomposition of individual components and in order to limit the energy consumption. A reaction temperature range particularly preferred according to the invention is 80° C. to 120° C.

In addition, the composition according to the present invention can contain further monomers and/or prepolymers that are able to copolymerize with the novolak and/or the curing agent, and optionally, as mentioned above, one or more other additives, in order to optimize the properties of the reaction mixtures and/or the three-dimensional objects produced. Thus, the composition can, for example, comprise vinyl ester, epoxy, furan, melamine formaldehyde or urea formaldehyde resins, or also polyol resins, saturated or unsaturated polyester resins, as well as alkyd resins as prepolymers, and/or bisphenol A diglycidyl ether (“BADGE”), 3,4-epoxycyclohexane carboxylic acid-3′,4′-epoxycyclohexylmethylester (“CE”), or another epoxy as a co-monomer.

Additives that may be added to the polymerizable composition can, for example, be one or more carboxylic acid anhydrides, which are preferably selected from dicarboxylic aid anhydrides, more preferably from phthalic acid anhydride, butane dicarboxylic acid anhydride, maleic acid anhydride, and cyclohexane-1,2-dicarboxylic acid anhydride. These also serve, among other things, as water scavengers by binding water released during the condensation reactions. Further possible additives are, for example, fillers common in phenolic resins as well as colorants and pigments, which can each be used in amounts that do not compromise the properties of the composition or the three-dimensional object obtained therefrom. Fillers that can be used comprise a wide range of inorganic and organic fillers, such as glass fibers, glass beads, clay minerals, silicates (silica, quartz, talc, mica), carbonates, iron powders, silanes, graphite, graphene, cork, carbon fibers, sawdust, wood fibers, cotton fibers, lignin, cellulose (fibers), thermosets, thermoplastic fibers, organoborates, and organophosphates, to name just a few. By adding them, various properties of the composition to be cured and of the objects to be produced therefrom can be varied within broad limits, such as their mechanical, thermal, or electric properties.

The exact ratios of the individual components of the photopolymerizable composition are not particularly limited and mainly depend on the respective type of the components and the properties of the three-dimensional objects to be produced in each case. In some preferred embodiments, the composition comprises 30 to 90 wt. % of novolak, 10 to 50 wt. % of a curing agent, and 1 to 10 wt. % of a photoacid generator, in particularly preferred embodiments 50 to 80 wt. % of novolak, 20 to 40 wt. % of a curing agent, and approximately 5 wt. % of a photoacid generator, in such proportions that their sum results in 100 wt. %. One or more further monomers and/or prepolymers can, for example, be added in such amounts that they replace up to 50% of the amount of novolak. And the carboxylic acid anhydrides mentioned above and serving as water scavengers can, for example, be added as additives in proportions of 5 to 25 wt. %, based on 100 wt. % as the sum of all components, preferably in proportions of 10 to 20 wt. %.

According to the invention, the generative manufacturing method preferably is a 3D printing method, more preferably a hot lithography method, by means of which three-dimensional objects with excellent mechanical properties can be produced very quickly and with excellent dimensional accuracy, usually by laser irradiation.

In a second aspect, the present invention provides, of course, also three-dimensional objects obtained by the novel inventive method defined above and having improved mechanical properties compared to the state of the art.

### SHORT DESCRIPTION OF THE FIGURE

FIG. 1, the only FIGURE, is a photograph of the three-dimensional objects produced in the examples according to the invention.

### EXAMPLES

Below, the invention will be described in more detail by means of examples and comparative examples, which are only given for illustrating the invention and are not to be understood as limiting. Unless otherwise indicated, the individual components of the photopolymerizable compositions were obtained from commercial sources and used without any further purification.

### General Procedure

The composition components given below were heated up to 80° C. under stirring in a container until a homogeneously distributed mixture was obtained, from which, in all cases in which a novolak was used as the phenolic resin, a highly viscous, practically solid mass was obtained after cooling to room temperature, while the comparative example using resol remained liquid after cooling. Then, 5 g each of the solid “blanks” and the liquid resol mixture were filled into a heatable tank of a hot lithography 3D printer Caligma 200 UV of Cubicure GmbH in Vienna, Austria, and heated to the stated reaction temperature, which resulted in a liquid layer with a thickness of several millimeters, which was then subjected to irradiation with the UV laser of the printer with a wavelength of 375 nm in order to print three-dimensional objects.

In this 3D printing method, a building platform is initially immersed into the liquefied composition from above and down to a defined distance from the tank bottom, which distance corresponds to the thickness of a layer to be cured, which again depends on the penetration depth of the light in the respective composition. Here, layer thicknesses of 50-100 μm were set in the examples. Subsequently, the UV laser sweeps over the bottom of the composition through the transparent tank bottom with a speed of up to 1000 mm/s controlled by a computer in order to cure the first layer, whereafter the building platform is raised by the amount corresponding the layer thickness, so that fresh liquid formulation can flow between the cured layer and the tank bottom, which is then again irradiated and thereby cured, etc.

### Phenolic Resins

The phenolic resin used as the novolak was in most examples Supraplast 3616 (“Novolak 1”) from Süd-West-Chemie GmbH in Neu-Ulm, Germany, which has a number-average molecular weight Mn of 341, a weight-average molecular weight Mw of 474, and, according to the manufacturer, a melting range of 30-50° C., a melting viscosity at 50° C. of 200-400 Pa·s, and a melting viscosity at 80° C. of 2-8 Pa·s. In addition, experiments with Durez 32303 (“Novolak 2”), a solid novolak with a melting point of approximately 80° C. and a melting viscosity at 100° C. of 0.55 Pa·s, as well as FERS FB8000SH (“Novolak 3”), a powdery novolak with a measured melting point of 77° C., both from Sumitomo Bakelite Europe N.V., were conducted. The phenolic resin used in Comparative Example 5 was Supraplast 052 (“Resol”) form Sud-WestChemie GmbH, a self-condensing resol resin that is viscous at room temperature (dynamic viscosity at 20° C. of up to 18 Pa·s) and has, according to the manufacturer, a gelling time at 100° C. of 70-90 mins and an initial boiling point >100° C.

### Photoinitiators

The following compounds were used as the photoacid generator (“photoacid generator”, PAG):
“PAG 1”: HRcure-9392 from Tianjin Huiren Chemtech Co., Ltd; 4-(octyloxy)phenyl)(phenyl)iodonium hexafluoroantimonate
“PAG 2”: SpeedCure 937 from Lambson Limited; bis(4-dodecylphenyl)iodonium hexafluoroantimonate
“PAG 3”: SpeedCure 976s from Lambson Limited; sulfanediyldibenzene-4,1-diyl)-bis(diphenylsulfonium) bis(hexafluoroantimonate)
“PAG 4”: Irgacure 290 from BASF Corporation; (4-(4-acetylphenylthio)phenyl) sulfonium tetrakis(pentafluorophenyl)borate

### Co-Monomers and Prepolymers

In Examples 13 to 16 and in Comparative Example 4, the two standard epoxy co-monomers, bisphenol A diglycidyl ether (“BADGE”) or 3,4-epoxycyclohexanecarboxylic acid-3′,4′-epoxycyclohexylmethylester (“CE”), respectively, were used:

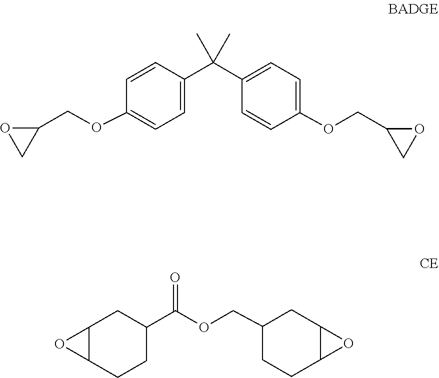 [SMILES: CC(C)(c1ccc(OCC2CO2)cc1)c1ccc(OCC2CO2)cc1 ; O=C(OCC1CCC2OC2C1)C1CCC2OC2C1]

The prepolymer capable to copolymerize used in Examples 17 and 18 was Epilok 60-838 (“prepolymer 1”), an epoxidized novolak resin from Bitrez Ltd. with a dynamic viscosity of approximately 40 Pa·s at 50° C. and of approximately 5 Pa·s at 70° C., in Example 19 it was Supraplast 680/95 (“prepolymer 2”), a melamine formaldehyde resin from Süd-West-Chemie GmbH with a melting range of 70-95° C., and in Example 20 it was Deuteron SF 707 (“prepolymer 3”), a urea formaldehyde resin liquid at room temperature from Deuteron GmbH in Achim, Germany.

### Curing Agents

The curing agents used in the formulations are each named in the overleaf Table 1 together with the other components, i.e., the phenolic resin (“resin”), the photoacid generator (“PAG”), and any other co-monomers/prepolymers (“COM/Pre”), their amounts in the tested formulations (in wt. % of the total composition), as well as the respective reaction temperatures (in ° C.) for the inventive Examples 1 to 22 (“E1” to “E22”) and Comparative Examples 1 to 5 (“C1” to “C5”).

TABLE 1
Formulations of Examples 1 to 22 and Comparative Examples 1 to 5

| Example | Resin | Wt. % | Curing agent | Wt. % | PAG | Wt. % | CoM/Pre | Wt. % | Temp. (° C.) |
|---|---|---|---|---|---|---|---|---|---|
| E1 | Novolak 1 | 80 | Paraformaldehyde | 15 | PAG 1 | 5 | — | — | 80 |
| E2 | Novolak 1 | 80 | Paraformaldehyde | 15 | PAG 2 | 5 | — | — | 80 |
| E3 | Novolak 1 | 80 | Paraformaldehyde | 15 | PAG 3 | 5 | — | — | 80 |
| E4 | Novolak 1 | 80 | Paraformaldehyde | 15 | PAG 4 | 5 | — | — | 80 |
| E5 | Novolak 1 | 75 | Trimethoxymethylene diacetate | 20 | PAG 1 | 5 | — | — | 80 |
| E6 | Novolak 1 | 75 | Trimethoxymethylene diacetate | 20 | PAG 2 | 5 | — | — | 80 |
| E7 | Novolak 1 | 75 | Trimethoxymethylene diacetate | 20 | PAG 3 | 5 | — | — | 80 |
| E8 | Novolak 1 | 75 | Trimethoxymethylene diacetate | 20 | PAG 4 | 5 | — | — | 80 |
| E9 | Novolak 1 | 55 | 4-Phenyl-1,3-dioxane | 40 | PAG 1 | 5 | — | — | 90 |
| E10 | Novolak 1 | 55 | 4-Phenyl-1,3-dioxane | 40 | PAG 2 | 5 | — | — | 90 |
| E11 | Novolak 1 | 55 | 4-Phenyl-1,3-dioxane | 40 | PAG 3 | 5 | — | — | 90 |
| E12 | Novolak 1 | 55 | 4-Phenyl-1,3-dioxane | 40 | PAG 4 | 5 | — | — | 90 |
| E13 | Novolak 1 | 40 | Paraformaldehyde | 15 | PAG 1 | 5 | BADGE | 40 | 80 |
| E14 | Novolak 1 | 37.5 | Trimethoxymethylene diacetate | 20 | PAG 1 | 5 | BADGE | 37.5 | 80 |
| E15 | Novolak 1 | 40 | Paraformaldehyde | 15 | PAG 1 | 5 | CE | 40 | 80 |
| E16 | Novolak 1 | 37.5 | Trimethoxymethylene diacetate | 20 | PAG 1 | 5 | CE | 37.5 | 80 |
| E17 | Novolak 1 | 40 | Paraformaldehyde | 15 | PAG 1 | 5 | Prepolymer 1 | 40 | 80 |
| E18 | Novolak 1 | 37.5 | Trimethoxymethylene diacetate | 20 | PAG 1 | 5 | Prepolymer 1 | 37.5 | 80 |
| E19 | Novolak 1 | 60 | Paraformaldehyde | 15 | PAG 1 | 5 | Prepolymer 2 | 20 | 80 |
| E20 | Novolak 1 | 60 | Paraformaldehyde | 15 | PAG 1 | 5 | Prepolymer 3 | 20 | 80 |
| E21 | Novolak 2 | 80 | Paraformaldehyde | 15 | PAG 1 | 5 | — | — | 80 |
| E22 | Novolak 3 | 80 | Paraformaldehyde | 15 | PAG 1 | 5 | — | — | 100 |
| C1 | Novolak 1 | 80 | Hexamethylenetetramine | 15 | PAG 1 | 5 | — | — | 80 |
| C2 | Novolak 1 | 85 | Paraformaldehyde | 15 | — | — | — | — | 80 |
| C3 | Novolak 1 | 95 | — | — | PAG 1 | 5 | — | — | 80 |
| C4 | Novolak 1 | 47.5 | — | — | PAG 1 | 5 | BADGE | 47.5 | 80 |
| C5 | Resol | 90 | — | — | PAG 1 | 10 | — | — | 80 |

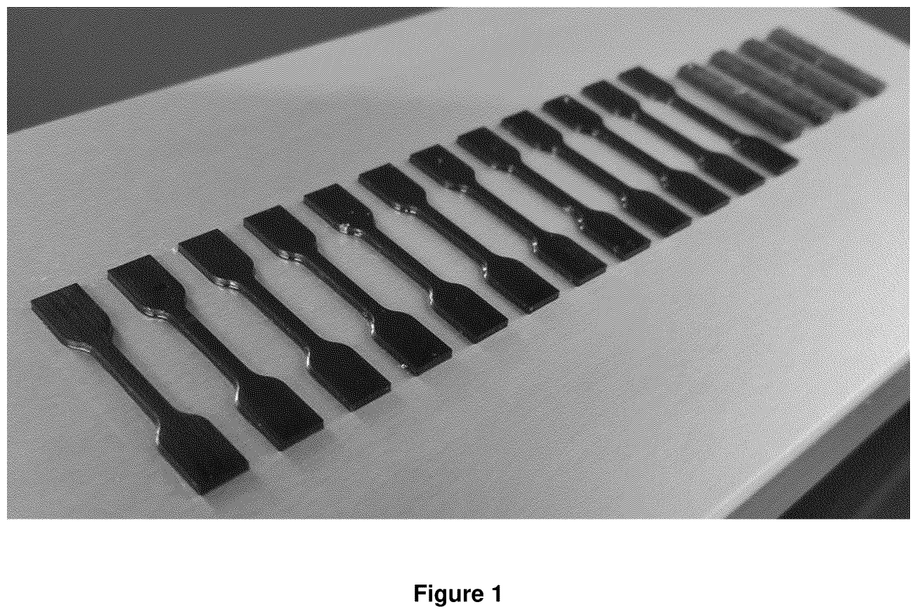

For the three-dimensional objects to be printed with the above polymerizable compositions, a pre-programmed design was selected, which approximately corresponded to a flattened dumbbell shape, as shown in the attached FIG. 1. The photography shows a row of twelve objects produced according to the invention, each with a thickness of 2 mm. The very right side of the picture shows four “blanks”, which were, as described above under “General procedure”, obtained by mixing the components under heating and then cooling to room temperature and subsequently also cured to an object with the target design by re-liquefaction in the 3D printer and irradiation with the UV laser.

In all cases, the desired object could be printed from the formulations listed above of the inventive Examples 1 to 22, which in each case consisted of a hard thermoset with the given composition that was not deformable or meltable anymore, even when heated.

In contrast, the five formulations of the comparative examples did mostly not result in a solid at all after re-liquefaction and irradiation in the 3D printer, i.e., the compositions heated to the respective reaction temperature of Comparative Examples 1 to 3 and 5 did not harden when irradiated. For Comparative Examples 2 and 3, where the photoacid generator or the curing agent were absent in the formulation, the negative results were not surprising for the skilled person. However, for Comparative Example 1, where instead of the paraformaldehyde of Example 1 the same amount of hexamethylenetetramine was used as the curing agent, which is typically used in the production of phenoplasts, this was rather surprising. Without wishing to be bound by any specific theory, the inventors attribute this negative result to the fact that the large amounts of ammonia that are released during decomposition of hexamethylenetetramine neutralize the photoacid formed by irradiation so that it is not able anymore to initiate the polycondensation of the novolak. For this reason, such amine-containing curing agents releasing ammonia during decomposition are excluded from the scope of the present invention.

It was also surprising that it was not possible to print a solid object using the resol resin, which is said to be self-condensing, of Comparative Example 5 in combination with 10 wt. % of photoacid generator-without any formaldehyde curing agent, however, this is probably due to the short reaction time and the low reaction temperatures in the 3D printing process.

Only in Comparative Example 4, where BADGE was used as co-monomer, but no formaldehyde curing agent was employed, a corresponding object was obtained from an unmeltable thermoset. Of course, this thermoset did not consist of novolak crosslinked with formaldehyde because crosslinking took place exclusively by cationic polymerization of the BADGE diepoxy. In view of the proportion between novolak and BADGE, which was no co-monomer, but the only monomer in this case, only half of the thermoplast obtained consisted of the phenoplast, while the other half was formed by an epoxy resin. For this reason, the mechanical properties of this molded article (glass transition temperature, stiffness and toughness) were significantly worse than those of the objects obtained in Examples 13 and 14, where also a 1:1 mixture of Novolak 1 and BADGE was used, however, with the addition of 15 wt. % of paraformaldehyde (Example 13) or 20 wt. % of trioxymethylenediacetate (Example 14), respectively, as the formaldehyde curing agent, as has been shown in subsequent examinations of the objects by means of a dynamic-mechanical thermoanalysis (DMTA).

In any case, the above explanations clearly show that with the inventive generative manufacturing methods, preferably 3D printing methods, it was possible for the first time to produce three-dimensional objects based on novolak thermosets crosslinked with formaldehyde that show excellent mechanical properties without the requirement of adding other binders or co-resins-even though this is also an option according the present invention.

1. A photopolymerizable composition comprising a phenol formaldehyde resin, a curing agent, and a photoinitiator for use in a generative manufacturing method for producing three-dimensional objects by irradiating it layer by layer to cure the composition,
wherein
a) the composition is heated to a reaction temperature of at least 70° C. before and during curing;
b) the composition comprises
b1) a novolak as said phenol formaldehyde resin,
b2) a formaldehyde derivative stable at the reaction temperature as said curing agent, and
b3) a photoacid generator as said photoinitiator; and
c) curing of the composition is conducted at normal pressure;
with the proviso that the curing agent is not an amine-containing formaldehyde derivative.

2. A generative manufacturing method for producing three-dimensional objects by irradiating, layer by layer, a photopolymerizable composition comprising a phenol formaldehyde resin, a curing agent, and a photoinitiator,
wherein
a) the composition is heated to a reaction temperature of at least 70° C. before and during curing;
b) the composition comprises
b1) a novolak as said phenol formaldehyde, which has a viscosity of not more than 20 Pa·s at the reaction temperature,
b2) a formaldehyde derivative stable at the reaction temperature as said curing agent, and
b3) a photoacid generator as said photoinitiator; and
c) curing of the composition is conducted at normal pressure;
with the proviso that the curing agent is not an amine-containing formaldehyde derivative.

3. The method according to claim 2, wherein a novolak is used as said phenol formaldehyde resin, which has a viscosity of not more than 10 Pa·s, not more than 5 Pa·s or not more than 1 Pa·s at the reaction temperature.

4. The method according to claim 2, wherein a formaldehyde derivative is used as said curing agent, which is present in its liquid state at the reaction temperature;
wherein the formaldehyde derivative is preferably selected from polyoxymethylene, polyoxymethylene diesters, polyoxymethylene diethers, as well as derivatives of 1,3-dioxolane and 1,3-dioxane, more preferably from 4-phenyl-1,3-dioxane as well as polyoxymethylene diacetate and other polyoxymethylene diesters.

5. The method according to claim 2, wherein a photoacid generator is used as said photoinitiator, which is selected from diaryliodonium and triarylsulfonium salts;
wherein the photoacid generator is preferably selected from corresponding hexafluoroantimonate, tetrafluoroborate and tetrakis(pentafluorophenyl)borate salts.

6. The use of method according to claim 2, wherein the composition is heated to a reaction temperature of not more than 130° C.;
wherein the composition is preferably heated to a temperature in the range of 80° C. to 120° C.

7. The use of method according to claim 2, wherein the composition contains further monomers and/or prepolymers that are able to copolymerize with the novolak and/or the curing agent, and optionally one or more other additives;
wherein the composition preferably comprises an epoxy, melamine formaldehyde or urea formaldehyde resin as said prepolymer or bisphenol A diglycidyl ether (“BADGE”), 3,4-epoxycyclohexane carboxylic acid-3′,4′-epoxycyclohexylmethylester (“CE”) or another epoxy as said co-monomer;
wherein the composition optionally comprises one or more carboxylic acid anhydrides as additives, which are preferably selected from dicarboxylic acid anhydrides and more preferably from phthalic acid anhydride, butane dicarboxylic acid anhydride, maleic acid anhydride, and cyclohexane-1,2-dicarboxylic acid anhydride.

8. The use of method according to claim 2, wherein the composition comprises 30 to 90 wt. % of novolak, 10 to 50 wt. % of a curing agent, and 1 to 10 wt. % of a photoacid generator in such proportions that their sum results in 100 wt. %;
wherein the composition preferably comprises 50 to 80 wt. % of novolak, 20 to 40 wt. % of a curing agent, and approximately 5 wt. % of a photoacid generator in such proportions that their sum results in 100 wt. %;
wherein optionally up to 50% of the novolak are replaced by one or more further monomers and/or prepolymers;
wherein the composition optionally further comprises 5 to 25 wt. % of a carboxylic acid anhydride as an additive in such proportions that the sum of all components results in 100 wt. %.

9. The method according to claim 2, wherein the generative manufacturing method is a 3D printing method.

10. A three-dimensional object obtained by a method according to claim 2.
